(19) United States
(12) Patent Application Publication
(10) Pub. No.: US 2024/0034662 A1
(43) Pub. Date: Feb. 1, 2024

(54) METHOD FOR HEATING LIQUID GLASS CHANNEL OF GLASS FIBER TANK FURNACE

(71) Applicant: JUSHI GROUP CO., LTD., Tongxiang (CN)

(72) Inventors: Yuqiang ZHANG, Tongxiang (CN); Guorong CAO, Tongxiang (CN); Peijun SHEN, Tongxiang (CN)

(21) Appl. No.: 18/483,329

(22) Filed: Oct. 9, 2023

Related U.S. Application Data
(63) Continuation of application No. 16/087,406, filed on Sep. 21, 2018.

(30) Foreign Application Priority Data
Aug. 19, 2016 (CN) 201610695498.7

(51) Int. Cl. C03B 5/235; C03B 7/06

(52) U.S. Cl. CPC C03B 5/2353; C03B 7/065; C03B 2207/81; C03B 2211/40

(57) ABSTRACT

A method for heating a liquid glass channel of a glass fiber tank furnace. The method comprises: passing oxygen gas and a fuel, via a burner (1), into a channel space (3) for combustion to heat the channel space (3) and a liquid glass (2), wherein the flow rate of the fuel is V_{F} and the flow rate of the oxygen gas is V_{OX} such that the relative velocity difference D=(V_{F}−V_{OX})V_{F}. The temperature of the channel is 0-1500° C., and the relative velocity difference D is kept to 25% or more. A pure oxygen combustion method is used for heating a tank furnace channel to reduce waste gas emission and heat loss, thereby achieving the goals of energy conservation, reduced carbon emissions, and improve environment friendliness. The fuel flow rate, relative velocity difference, and related parameters can be controlled according to the temperature of the channel, providing excellent uniformity and accurate control of the temperature of the channel.

### CROSS-REFERENCE TO RELATED APPLICATIONS

The present application is a continuation of application Ser. No. 16/087,406, filed on Sep. 21, 2018, which is a National Stage Entry under 35 U.S.C. § 371 of International Application No. PCT/CN2016/098470, filed on Sep. 8, 2016, which claims priority to Chinese Patent Application No. 201610695498.7, filed on Aug. 19, 2016 and entitled “Method for heating liquid glass channel of glass fiber tank furnace”, the entire contents of all of which are incorporated herein by reference.

### FIELD OF THE INVENTION

The invention relates to glass melting technology, in particular, to a method for heating liquid glass channel of glass fiber tank furnace.

### BACKGROUND OF THE INVENTION

The glass fiber tank furnace comprises melting end and the channel, the melting end adopts oxy-fuel combustion technology, which has been applied in China and abroad, However, the channel still uses air combustion at present, or heats the air and fuel to about 1000° C. and then switches to oxy-fuel combustion.

Air combustion has the following problems: Firstly, the flame temperature of the air combustion is not high, the heat radiation capability is weak, and in the combustion process, a large amount of nitrogen in the air enters the channel and is discharged from the flue after absorbing a large amount of heat, thus leading to the low utilization efficiency of combustion heat and the growing production cost in fiberglass industry. Secondly, the accuracy of temperature control for air combustion is relatively poor, which leads to uneven temperature in the channel space and further results in uneven expansion of the refractory materials. This would easily affect the channel structure and has certain hidden danger. Thirdly, by using the air combustion technology, the ignition temperature is generally higher and the heating requirement of the channel under a low-temperature condition cannot be satisfied.

With the fierce competition in the fiberglass industry, the fuel prices are rising. In order to reduce the energy consumption and production cost, and to respond to the national requirement on energy conservation and emission reduction, the heating process of glass fiber tank furnace channel and the combustion methods of the normal production need to be changed. It is an inevitable trend to use oxy-fuel combustion technology for the channel, but there remain big problems in the oxy-fuel combustion for the channel, especially the technical problems such as inaccurate and uneven control of temperatures. If the flow rates of fuel and oxygen cannot be controlled properly, it may cause the flame to be too short or the temperature to be too high, which will damage the burner and refractory materials, and reduce the service life of the channel.

### SUMMARY OF THE INVENTION

The present invention aims to provide a method for heating liquid glass channel of glass fiber tank furnace that can solve the aforesaid problems. The method which uses a special burner to heat the channel space and liquid glass can not only improve the flame temperature and the utilization efficiency of heat, but also reduce waste gas generated and the heat brought away by the waste gas in the combustion process, thereby reducing the energy consumption and the cost of production, achieving the goal of energy conservation, emission reduction and environmental protection.

A method for heating a liquid glass channel of a glass fiber tank furnace is provided comprising: passing oxygen and fuel, via a burner 1, into a channel space 3 for combustion to heat the channel space 3 and liquid glass 2;
wherein a flow rate of the fuel is V_{F} and a flow rate of the oxygen is V_{OX} and a relative velocity difference is D=(V_{F}−V_{OX})/V_{F}. A temperature of the channel is 0-1500° C., and the relative velocity difference expressed as D is greater than 25%.

Wherein, a range of the flow rate of the fuel expressed as V_{F} is 0-100 m/s, and a range of the flow rate of the oxygen expressed as V_{OX} is 0-10 m/s.

Wherein, when the channel temperature is controlled to be greater than 0° C. and less than or equal to 500° C., a range of the relative velocity difference expressed as D is controlled to be greater than 25% and less than or equal to 50%.

Wherein, when the channel temperature is controlled to be greater than 500° C. and less than or equal to 1000° C., a range of the relative velocity difference expressed as D is controlled to be greater than 50% and less than or equal to 90%.

Wherein, when the channel temperature is controlled to be greater than 1000° C. and less than or equal to 1500° C., a range of the relative velocity difference expressed as D is controlled to be greater than 90%.

Wherein, when the channel temperature is controlled to be greater than 0° C. and less than or equal to 500° C., a range of the flow rate of the fuel expressed as V_{F} is controlled to be greater than 0% and less than or equal to 15 m/s.

Wherein, when the channel temperature is controlled to be greater than 500° C. and less than or equal to 1000° C., a range of the flow rate of the fuel expressed as V_{F} is controlled to be greater than 15 m/s and less than or equal to 50 m/s.

Wherein, when the channel temperature is controlled to be greater than 1000° C. and less than or equal to 1500° C., a range of the flow rate of the fuel expressed as V_{F} is controlled to be greater than 50 m/s and less than or equal to 100 m/s.

Wherein, when the channel temperature is greater than 0° C. and less than or equal to 500° C., a range of the relative velocity difference expressed as D is controlled to be greater than 25% and less than or equal to 50%, and a range of the flow rate of the fuel expressed as V_{F} is controlled to be greater than 0 m/s and less than or equal to 15 m/s; when the channel temperature is greater than 500° C. and less than or equal to 1000° C., the range of the relative velocity difference expressed as D is controlled to be greater than 50% and less than or equal to 90%, and the range of the flow rate of the fuel expressed as V_{F} is controlled to be greater than 15 m/s and less than or equal to 50 m/s; when the channel temperature is greater than 1000° C. and less than or equal to 1500° C., the range of the relative velocity difference expressed as D is controlled to be greater than 90%, and the range of the flow rate of the fuel expressed as V_{F} is controlled to be greater than 50 m/s and less than or equal to 100 m/s.

Wherein, a range of a flame temperature is 1000-1800° C.

The combustion at the melting end of tank furnace is mainly to heat the glass raw materials and melt glass into molten glass, yet the heating of liquid glass channel is to keep the liquid state of the molten glass, and adjust the properties such as viscosity of molten glass. The quality of molten glass in the channel has a great influence on the subsequent operation of forming glass fiber. Thereby, the heating method of the channel has higher requirement for temperature uniformity. According to the method for heating liquid glass channel of the present invention, mainly by controlling the relative velocity difference of fuel and oxygen in the combustion process, it can maintain the temperature uniformity of the channel at different temperatures, significantly improve the heat radiation capability and the heat utilization efficiency, reduce heat loss, and have advantages such as energy conservation and environmental protection.

Specifically, oxygen and fuel are fed into channel space via a burner for combustion to heat the channel space and liquid glass. In present invention, the fuel includes combustible materials such as natural gas or liquefied petroleum gas; the flow rate of the fuel is V_{F}, the flow rate of the oxygen is V_{OX}, and the relative velocity difference D=(V_{F}−V_{OX})/V_{F}. According to the present invention, oxygen is used as combustion-supporting gas to effectively compensate for the disadvantages of air combustion, such as low flame temperature and weak heat radiation capability, and further avoid the heating of nitrogen in air, so as to effectively improve heat utilization efficiency.

The heating method of the present invention is suitable for the channel temperature of 0-1500° C. Specifically, the channel temperature can be heated from normal temperature to 1500° C. The present invention adopts the method using fuel and oxygen for combustion and deeply studies the oxy-fuel combustion technology of the channel. It is essential to control the relative velocity of fuel and oxygen for this technology. In the present invention, the range of the relative velocity difference expressed as D should be greater than 25%. If the relative velocity difference expressed as D is less than 25%, the fuel flow will be relatively low and the oxygen flow will be relatively high, that will cause short flame of burner, high temperature of burner outlet, low heat radiation, low heat utilization efficiency and big heat loss.

Wherein, the restricted range of the flow rate of the fuel expressed as V_{F} is 0-100 m/s, which can not only meet the different temperature requirements of the channel, but also maintain the proper flame length. The flow rate of the fuel being too high will easily cause too long combustion flame, which would easily burn the refractory materials and cause the local temperature of the refractory materials to be too high and further result in cracking of refractory, materials. Meanwhile, considering the combustion reaction of fuel and oxygen in the channel, the restricted range of the flow rate of the oxygen expressed as V_{OX} is 0-10 m/s.

Furthermore, different channel temperatures need different relative velocity differences. When the channel temperature is greater than 0° C., and less than or equal to 500° C., that is, the channel temperature is relatively low, in order to maintain the uniformity of the channel temperature it is necessary to control the relative velocity of oxygen and fuel. Under this situation, as the channel temperature is relatively low, the gas flow in the burner is relatively low, and the flow rate of fuel is relatively low. In order to maintain the uniformity of the channel temperature, the range of the relative velocity difference expressed as D is controlled to be greater than 25% and less than or equal to 50%.

Furthermore, the inventors have found that, when the channel temperature is greater than 0° C. and less than or equal to 500° C., it would be more energy efficient for the range of the flow rate of the fuel expressed as V_{F} to be controlled greater than 0 m/s and less than or equal to 15 m/s,. Preferably, when the channel temperature is less than or equal to 500° C., the range of the relative velocity difference expressed as D can be controlled to be greater than 25% and less than or equal to 50%, and the range of the flow rate of the fuel expressed as V_{F} to be greater than 0 m/s and less than or equal to 15 m/s, which can not only heat the liquid glass channel effectively and maintain uniformity of the temperature, but also can significantly improve the heat utilization efficiency.

When the channel temperature is greater than 500° C., and less than or equal to 1000° C., in order to maintain the uniformity of the channel temperature, the range of the relative velocity difference expressed as D is controlled to be greater than 50% and less than or equal to 90%. Under this situation, the flame length of the burner just covers the width direction of the channel, and the flame will not burn the refractory materials opposite to it or cause the refractory materials to be damaged due to the uneven heating.

Furthermore, the inventors have found that, when the channel temperature is greater than 500° C. and less than or equal to 1000° C., the range of the flow rate of the fuel expressed as V_{F} is controlled to be greater than 15 m/s and less than or equal to 50 m/s, which can be more energy efficient, save the consumption of materials and help achieve stable combustion. Preferably, when the channel temperature is greater than 500° C. and less than or equal to 1000° C., the range of the relative velocity difference expressed as D is controlled to be greater than 50% and less than or equal to 90%, and the range of the flow rate of the fuel expressed as V_{F} is controlled to be greater than 15 m/s and less than or equal to 50 m/s. These controlling measures can significantly improve the heat radiation capability and heat utilization efficiency, reduce heat loss, and provide high accuracy of combustion control.

When the channel temperature is greater than 1000° C. and less than or equal to 1500° C., in order to achieve a higher temperature of the channel, the burning velocity of the fuel need to be relatively higher. On the other hand, to prevent excess large flame from burning refractory materials, the range of the relative velocity difference of the fuel and the oxygen expressed as D is controlled to be greater than 90%, and the relative velocity difference is controlled to be greater than 90%, so that the temperature of the channel can quickly reach the production temperature.

Furthermore, the inventors have found that, when the channel temperature is greater than 1000° C. and less than or equal to 1500° C., the range of the flow rate of the fuel expressed as V_{F} is controlled to be greater than 50 m/s and less than or equal to 100 m/s. This flow rate of the fuel can meet the requirement of fast combustion and maintain the channel temperature at a high level. Preferably, when the channel temperature is greater than 1000° C. and less than or equal to 1500° C., the range of the relative velocity difference expressed as D is controlled to be greater than 90%, and the range of the flow rate of the fuel expressed as V_{F} is controlled to be greater than 50 m/s and less than or equal to 100 m/s. These controlling measures can effectively prevent the flame of the burner from being too short or too large, thereby avoiding burning the burner or the refractory materials, and offering high accuracy of combustion control and better uniformity of the channel temperature.

The oxy-fuel combustion has technical problems such as inaccurate and unevenness control of temperature due to the high concentration of oxygen. The present invention adopts grading control for the flow rate of the fuel and the relative velocity difference of fuel and oxygen according to different channel temperatures.

Specifically, when the channel temperature is greater than 0° C. and less than or equal to 500° C., the range of the relative velocity difference expressed as D is controlled to be greater than 25% and less than or equal to 50%, and the range of the flow rate of the fuel expressed as V_{F} is controlled to be greater than 0 m/s and less than or equal to 15 m/s; when the channel temperature is greater than 500° C. and less than or equal to 1000° C., the range of the relative velocity difference expressed as D is controlled to be greater than 50% and less than or equal to 90%, and the range of the flow rate of the fuel expressed as V_{F} is controlled to be greater than 15 m/s and less than or equal to 50 m/s, when the channel temperature is greater than 1000° C. and less than or equal to 1500° C., the range of the relative velocity difference expressed as D is controlled to be greater than 90%, and the range of the flow rate of the fuel expressed as V_{F} is controlled to be greater than 50 m/s and less than or equal to 100 m/s. This combustion method simultaneously restricts the relative velocity difference expressed as D and the flow rate of the fuel expressed as V_{F} according to the channel temperature, and achieves accurate control of the channel temperature. This method used to heat the channel can effectively prevent the flame from being too short or too long, provide better uniformity temperature of the channel, and significantly improve the heat utilization efficiency of combustion.

In the present invention, by controlling the rate of the fuel and the relative velocity difference of the fuel and the oxygen, the flame temperature of the combustion can be as high as 1000-1800° C., and the combustion has high emissivity of flame, strong radiation capability and high heat utilization efficiency.

Compared with the prior art, the present invention has the following beneficial effects:

First, the combustion method provided in the present invention uses fuel and oxygen for combustion, and studies the relative velocity relationship of the fuel and the oxygen, which effectively compensates for various defects in air combustion and increases flame temperature and heat utilization efficiency.

Secondly, the present invention adopts grading control for the relative velocity difference expressed as D and the flow rate of the fuel expressed as V_{F} according to the different channel temperatures, which realizes accurate control of different channel temperatures.

Thirdly, the combustion method provided in the present invention enables the temperature of the channel to quickly reach the target temperature, maintains uniformity of the temperature, and reduces energy consumption and cost of production, thereby achieving the goal of energy conservation, emission reduction and environmental protection.

### BRIEF DESCRIPTION OF THE DRAWINGS

The accompanying drawings incorporated into the description and constituting part of the description show the embodiments of the present invention, and are used to explain the principle of the present invention together with the description. In these drawings, similar reference numbers are used to denote similar elements. The drawings described below show some but not all of the embodiments of the present invention. For a person of ordinary skill in the art, other drawings can be obtained according to these drawings without paying any creative effort.

FIG. 1 is a schematic diagram of a liquid glass channel structure according to the present disclosure.

### DETAILED DESCRIPTION OF THE INVENTION

In order to better clarify the purposes, technical solutions and advantages of the examples of the present invention, the technical solutions in the examples of the present invention are clearly , and completely described below in combination with the drawings in the examples. Obviously, the examples described herein are just part of the examples of the present invention and are not all the examples. All other exemplary embodiments obtained by one skilled in the art on the basis of the examples in the present invention without performing creative work shall all fall into the scope of protection of the present invention. What needs to be made dear is that, as long as there is no conflict, the examples and the features of examples in the present application can be arbitratily combined with each other.

### Embodiment 1

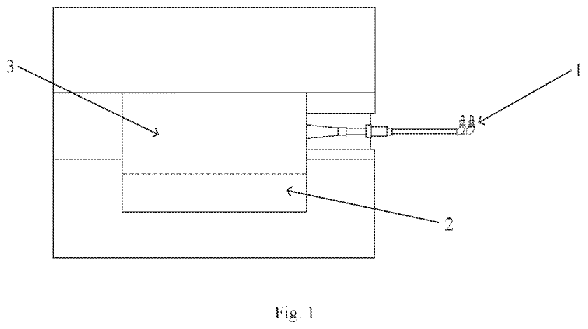

In actual production, the channel temperature is maintained at 1400° C. for a long time. Then at this temperature, the heating method of the present invention is compared with the traditional air heating method. Referring to FIG. 1, passing the oxygen and the fuel, with a certain velocity, via a burner 1, into a channel space 3 for combustion to heat the channel space 3 and liquid glass 2 in the channel; wherein the flow rate of the fuel is V_{F} and the flow rate of the oxygen is V_{OX}, the relative velocity difference is D=(V_{F}−V_{OX})/V_{F}. The amounts of fuel consumed for per kilogram of molten glass by adopting different heating methods are shown in Table 1:

TABLE 1
Fuel consumption by adopting different heating methods

| | | | | | Fuel |
|---|---|---|---|---|---|
| | | | | Flow | consumption/ |
| | | Relative | Flow | rate | (Nm³/ |
| | Channel | velocity | rate of | of the | Kilogram |
| | temperature/ | difference | the fuel/ | oxygen/ | of molten |
| No. | ° C. | D | (m/s) | (m/s) | glass) |
| 1 | 1400 | 86.1% | 65 | 9 | 0.018 |
| 2 | 1400 | 92% | 50 | 4 | 0.022 |
| 3 | 1400 | 91% | 100 | 9 | 0.01 |
| Air | 1400 | — | — | — | 0.09 |
| combustion | | | | | |

When the channel temperature is maintained at 1400° C., the fuel consumption of air combustion is 0.09 Nm³/Kilogram of molten glass, the fuel consumption of the combustion method numbered 1-3 in Table 1 are 0.018 Nm³/Kilogram of molten glass, 0.022 Nm³/Kilogram of molten glass and 0.01 Nm³/Kilogram of molten glass, respectively. The combustion method provided in present invention greatly reduces the energy consumption, effectively improves the heat utilization efficiency by controlling the relative velocity of the fuel and the oxygen. Wherein, the combustion method numbered 3 in Table 1 has the lowest energy consumption.

### Embodiment 2

Referring to FIG. 1, passing the oxygen and the fuel, with a certain velocity, via a burner 1, into a channel space 3 for combustion to heat the channel space 3 and the liquid glass 2 in the channel; wherein the flow rate of the fuel is V_{F} and the flow rate of the oxygen is V_{OX} such that the relative velocity difference is D=(V_{F}−V_{OX})/V_{F}. Table 2 shows the flow rates of the fuel and the oxygen at different channel temperatures.

TABLE 2
Channel temperatures and the related combustion parameters

| | | Relative | | |
|---|---|---|---|---|
| | Channel | velocity | | Flow rate |
| | temperature/ | difference | Flow rate of | of the |
| No. | ° C. | D | the fuel/(m/s) | oxygen/(m/s) |
| 1 | 300 | 54.5% | 5.5 | 2.5 |
| 2 | 400 | 40.6% | 16 | 9.5 |
| 3 | 500 | 37.5% | 4 | 2.5 |
| 4 | 600 | 74.3 | 14 | 3.6 |
| 5 | 800 | 91% | 40 | 3.6 |
| 6 | 1000 | 77.1% | 35 | 8 |
| 7 | 1100 | 92% | 50 | 4 |
| 8 | 1300 | 90% | 90 | 9 |
| 9 | 1500 | 91% | 100 | 9 |

The combustion methods numbered 1-9 in Table 2, by controlling the relative velocity of the oxygen and the fuel, enable the temperature of the channel to quickly reach the target temperature, have good uniformity of the temperature, and have the flame temperature as high as 1000-1800° C., have strong radiation capability, effectively improve the heat utilization efficiency, and reduce the heat loss.

Wherein, the methods numbered 3, 6 and 9 can control the channel temperature more accurately and achieve better uniformity of the channel temperature.

It can be seen from the above tables that, compared with the prior art, the present invention has the following beneficial effects:

First, the combustion method provided in the present invention uses fuel and oxygen for combustion, and studies the relative velocity relationship of the fuel and the oxygen, which effectively compensates for various defects in air combustion and improves the flame temperature and heat utilization efficiency.

Secondly, the present invention adopts grading control for the relative velocity difference expressed as D and the flow rate of the fuel expressed as V_{F} according to the different channel temperatures, which realizes the accurate control of different channel temperatures.

Thirdly, the combustion method provided in the present invention enables the temperature of the channel to quickly reach the target temperature, maintains uniformity of the temperature, reduces the energy consumption and cost of production, thereby achieving the goal of energy conservation, emission reduction and environmental protection.

Finally, what should be made clear is that, in this text, the terms “contain”, “comprise” or any other variants are intended to mean “nonexclusively include” so that any process, method, article or equipment that contains a series of factors shall include not only such factors, but also include other factors that are not explicitly listed, or also include intrinsic factors of such process, method, object or equipment. Without more limitations, factors defined by the phrase “contain a . . . ” or its variants do not rule out that there are other same factors in the process, method, article or equipment which include said factors.

The above examples are provided only for the purpose of illustrating instead of limiting the technical solutions of the present invention. Although the present invention is described in details by way of aforementioned examples, one skilled in the art shall understand that modifications can also be made to the technical solutions embodied by all the aforementioned examples or equivalent replacement can be made to some of the technical features. However, such modifications or replacements will not cause the resulting technical solutions to substantially deviate from the spirits and ranges of the technical solutions respectively embodied by all the examples of the present invention.

### INDUSTRIAL APPLICABILITY OF THE INVENTION

The present invention adopts oxy-fuel combustion to heat the liquid glass channel of the tank furnace, studies the relative velocity relationship of the fuel and the oxygen. By controlling the relative velocity difference of the fuel and the oxygen expressed as D and the flow rate of the fuel expressed as V_{F}, it can realize the accurate control of different channel temperatures, enable the temperature of the channel to quickly reach the target temperature, maintain uniformity of the temperature, reduce the energy consumption and cost of production, thereby achieving the goal of energy conservation, emission reduction and environmental protection.

1. A method for heating a liquid glass channel of a glass fiber tank furnace, wherein, comprising: passing oxygen and fuel, via a burner (1), into a channel space (3) for combustion to heat the channel space (3) and liquid glass (2);
wherein a flow rate of the fuel is V_{F}, a flow rate of the oxygen is V_{OX}, a relative velocity difference is D=(V_{F}−V_{OX})/V_{F}, a temperature of the channel is 0-1500° C., and the relative velocity difference expressed as D is greater than 25%.

2. The method for heating liquid glass channel of glass fiber tank furnace of claim 1, wherein a range of the flow rate of the fuel expressed as V_{F} is 0-100 m/s, and a range of the flow rate of the oxygen expressed as V_{OX} is 0-1 m/s.

3. The method for heating liquid glass channel of glass fiber tank furnace of claim 1, wherein, when the channel temperature is controlled to be greater than 0° C. and less than or equal to 500° C., a range of the relative velocity difference expressed as D is controlled to be greater than 25% and less than or equal to 50%.

4. The method for heating liquid glass channel of glass fiber tank furnace of claim 1, wherein, when the channel temperature is controlled to be greater than 500° C. and less than or equal to 1000° C., a range of the relative velocity difference expressed as D is controlled to be greater than 50% and less than or equal to 90%.

5. The method for heating liquid glass channel of glass fiber tank furnace of claim 1, wherein, when the channel temperature is controlled to be greater than 1000° C. and less than or equal to 1500° C., a range of the relative velocity difference expressed as D is controlled to be greater than 90%.

6. The method for heating liquid glass channel of glass fiber tank furnace of claim 1, wherein, when the channel temperature is controlled to be greater than 0° C. and less than or equal to 500° C., a range of the flow rate of the fuel expressed as V_{F} is controlled to be greater than 0 m/s and less than or equal to 15 m/s.

7. The method for heating liquid glass channel of glass fiber tank furnace of claim 1, wherein, when the channel temperature is controlled to be greater than 500°C. and less than or equal to 1000° C., a range of the flow rate of the fuel expressed as V_{F} is controlled to be greater than 1.5 m/s and less than or equal to 50 m/s.

8. The method for heating liquid glass channel of glass fiber tank furnace of claim 1, wherein, when the channel temperature is controlled to be greater than 1000° C. and less than or equal to 1500° C., a range of the flow rate of the fuel expressed as V_{F} is controlled to be greater than 50 m/s and less than or equal to 100 m/s.

9. The method for heating liquid glass channel of glass fiber tank furnace of claim 1, wherein, when the channel temperature is greater than 0° C. and less than or equal to 500° C., a range of the relative velocity difference expressed as D is controlled to be greater than 25% and less than or equal to 50%, and a range of the flow rate of the fuel expressed as V_{F} is controlled to be greater than 0 m/s and less than or equal to 15 m/s; when the channel temperature is greater than 500° C. and less than or equal to 1000° C., the range of the relative velocity difference expressed as D is controlled to be greater than 50% and less than or equal to 90%, and the range of the flow rate of the fuel expressed as V_{F} is controlled to be greater than 15 m/s and less than or equal to 50 m/s; when the channel temperature is greater than 1000° C. and less than or equal to 1500° C., the range of the relative velocity difference expressed as D is controlled to be greater than 90%, and the range of the flow rate of the fuel expressed as V_{F} is controlled to be greater than 50 m/s and less than or equal to 100 m/s.

10. The method for heating liquid glass channel of glass fiber tank furnace of claim 1, wherein a range of a flame temperature is 1000-1800° C.

11. The method for heating liquid glass channel of glass fiber tank furnace of claim 3, wherein, when the channel temperature is controlled to be greater than 0° C. and less than or equal to 500° C., a range of the flow rate of the fuel expressed as V_{F} is controlled to be greater than 0 m/s and less than or equal to 15 m/s.

12. The method for heating liquid glass channel of glass fiber tank furnace of claim 4, wherein, when the channel temperature is controlled to be greater than 500° C. and less than or equal to 1000° C., a range of the flow rate of the fuel expressed as V_{F} is controlled to be greater than 15 m/s and less than or equal to 50 m/s.

13. The method for heating liquid glass channel of glass fiber tank furnace of claim 5, wherein, when the channel temperature is controlled to be greater than 1000° C. and less than or equal to 1500° C., a range of the flow rate of the fuel expressed as V_{F} is controlled to be greater than 50 m/s and less than or equal to 100 m/s.
